(19) United States
(12) Patent Application Publication
(10) Pub. No.: US 2008/0140623 A1
(43) Pub. Date: Jun. 12, 2008

(54) Recursive reporting via a spreadsheet

(75) Inventors: Ian Tien, Seattle, WA (US); Corey Hulen, Sammamish, WA (US); Chen-I Lim, Seattle, WA (US)

Correspondence Address: MICROSOFT CORPORATION, ONE MICROSOFT WAY, REDMOND, WA, 98052-6399, US

(73) Assignee: Microsoft Corporation, Redmond, WA (US)

(21) Appl. No.: 11/636,884

(22) Filed: Dec. 11, 2006

(51) Int. Cl. G06F 17/30

(52) U.S. Cl. 707/3

(57) ABSTRACT

Architecture for accessing a repository of information and recursively processing the repository information for relevant information for output as a spreadsheet. Once the relevant information is returned, portions of the relevant information are used to develop and execute one or more queries against data sources for information related to the relevant information. A report is then generated in the form of a spreadsheet that includes the relevant and related information presented as one or more of text, a chart, a graph, matrix, and other combinations of visualizations and perceivable information (e.g., audio data). Moreover, the spreadsheet can include a hierarchical organization of sheets based on relationships in stored metadata definitions. The one or more queries can be processed against backend data sources under a centralized security regime optimized for rapidly aggregating data from across heterogeneous data sources.

### BACKGROUND

Networks have made possible the storage and access to enormous amounts of information. However, the information is provided in many different formats using many different applications. This continues to present a problematic situation for information access and processing by general users on major networks such as the Internet. Similarly, corporations generate and store large amounts of information on enterprise networks for conducting business.

Basic employee proficiency with ubiquitous applications such as word processors or spreadsheets is becoming a necessity. Spreadsheets can be a useful tool for receiving and formatting data for useful purposes (e.g., presentation). Moreover, once data has been moved into a spreadsheet subsequent manipulation can be easier since many users are more proficient at interacting with spreadsheet data than more complex and unfamiliar tools. However, rather than use automated means for importing data into the application, a significant portion of the millions of spreadsheet users throughout the world spend time inefficiently by manually transferring data from source systems into spreadsheets. The task is tedious, error prone and wastes time that could be better spent analyzing the data rather than transferring and reformatting it.

In a corporate environment where compliance has become a multi-billion dollar industry, the consequences for lack of transparency into the composition and behavior of data have largely become intolerable. In order to access and examine business information to understand the health of the company, for example, specially trained employees or contracted outside sources can be required to utilize complex programs for analyzing, compiling and presenting corporate information to interested users. For example, understanding business logic stored in calculations and programming requires specialized training that often deprives many people in the enterprise of the ability to understand the assumptions on which decisions are based.

The knowledge required to use new and more complex applications and associated capabilities exceeds what the general user will typically learn when using word processing and spreadsheet applications. Accordingly, companies continually strive for means for obtaining and viewing information in a more user-friendly format and via applications where user interaction can be more efficient and productive.

### SUMMARY

The following presents a simplified summary in order to provide a basic understanding of some aspects of the disclosed innovation. This summary is not an extensive overview, and it is not intended to identify key/critical elements or to delineate the scope thereof. Its sole purpose is to present some concepts in a simplified form as a prelude to the more detailed description that is presented later.

The disclosed architecture provides a mechanism for accessing a repository (or data source) of information (e.g., business definitions) and recursively processing the repository information for relevant information. Once the relevant information is returned, portions of the relevant information can be used to develop and execute one or more queries against the same or different data sources for information related to the relevant information. A report can then be generated in the form of a spreadsheet that includes the relevant and/or related information presented as one or more of text, a chart, a graph, matrix, and other combinations of visualizations and perceivable information (e.g., audio data). Moreover, the spreadsheet can include a hierarchical organization of sheets based on relationships stored in metadata definitions. The one or more queries can be processed against backend data sources under a centralized security regime optimized for rapidly aggregating data from across heterogeneous data sources.

Other capabilities of the architecture facilitate the spreadsheet report being output in a compressed XML (extensible markup language) format. Additionally, the relevant and/or related information can include unstructured data (e.g., comments), the report can be automatically and/or manually distributed via a messaging technology (e.g., e-mail), and the spreadsheet report can be partitioned into smaller reports and presented over multiple presentation units (e.g., slides, user interface pages, documents). Content can be auto-sized as part of the report(s), themes and formatting can be applied, and images compressed into an output format.

Caching of data is provided to facilitate data access, report generation, searching and spreadsheet formatting and presentation, for example. Caching also supports scaling out the system and for loading balancing of relevant and/or related information.

The architecture also can provide automated capture of documents or data (e.g., snapshots), the grouping of spreadsheet slides by category (e.g., a key performance indicator (KPI)), break-out of spreadsheet sheets for presentation by dimension members, and automatic generation of end-user briefing books by subscription.

To the accomplishment of the foregoing and related ends, certain illustrative aspects of the disclosed innovation are described herein in connection with the following description and the annexed drawings. These aspects are indicative, however, of but a few of the various ways in which the principles disclosed herein can be employed and is intended to include all such aspects and their equivalents. Other advantages and novel features will become apparent from the following detailed description when considered in conjunction with the drawings.

### BRIEF DESCRIPTION OF THE DRAWINGS

FIG. 1 illustrates a system that facilitates data management in accordance with the disclosed innovation.

FIG. 2 illustrates a method of managing data in accordance with the innovation.

FIG. 3 illustrates an alternative system for recursively accessing data and outputting information in a spreadsheet.

FIG. 4 illustrates a system wherein the formatting component employs hierarchical data to generate a structured spreadsheet report.

FIG. 5 illustrates components associated with the formatting component that can be employed for preparing and inserting information into the spreadsheet report.

FIG. 6 illustrates an alternative implementation of a formatting component that includes an organizational component for organizing and outputting a spreadsheet report in predetermined ways.

FIG. 7 illustrates a method of processing unstructured data for inclusion in a spreadsheet.

FIG. 8 illustrates a method of capturing information for presentation in a spreadsheet.

FIG. 9 illustrates a method of distributing a spreadsheet report in accordance with the innovation.

FIG. 10 illustrates a method of organizing and presenting business information by dimension members.

FIG. 11 illustrates a method of organizing spreadsheet output according to a slide format.

FIG. 12 illustrates a method of caching information in support of generating a spreadsheet of business performance information.

FIG. 13 illustrates a screenshot of a scorecard of KPI information obtained and compiled from a search for reporting via a spreadsheet.

FIG. 14 illustrates a screenshot of a spreadsheet that includes the KPI scorecard information compiled in FIG. 13.

FIG. 15 illustrates a screenshot of one page of a user interface for selecting a scorecard to export to a spreadsheet and output the spreadsheet as a briefing book.

FIG. 16 illustrates a screenshot of one page of a user interface for specifying an export option for exporting a scorecard to a spreadsheet and outputting output the spreadsheet as a briefing book.

FIG. 17 illustrates a block diagram of a computing system operable to execute the disclosed architecture for recursive access of relevant and/or related information for output into a spreadsheet.

FIG. 18 illustrates a schematic block diagram of an exemplary computing environment that recursive processing of business definitions for output in one or more spreadsheets.

### DETAILED DESCRIPTION

Spreadsheets can be a tool for receiving and formatting data for useful purposes (e.g., presentation). Moreover, once data has been moved into a spreadsheet subsequent manipulation can be easier since many users are more proficient at interacting with spreadsheet data than more complex and unfamiliar application tools.

The innovation provides means for visiting a repository (or data source) of information (e.g., business definitions), and recursively accessing, searching and generating data (e.g., charts, graphs, matrixes, and other visualizations) for inclusion into one or more spreadsheets. The sheets of a spreadsheet can be ordered according to a hierarchy of relationships stored in metadata definitions. The business definitions and reports visited, in turn, can be utilized to execute a series of queries to the same or other data sources (e.g., backend) under a centralized security regime optimized for rapidly aggregating data from across heterogeneous data sources. The benefit to end users of the recursive capabilities described herein is the ability to not only save time and energy from the repetitive task of creating reporting spreadsheets, but also in being able to more quickly understand data patterns and relationships that would have been too complex and time consuming to have been assembled and analyzed without the benefit of recursive automation.

The innovation is now described with reference to the drawings, wherein like reference numerals are used to refer to like elements throughout. In the following description, for purposes of explanation, numerous specific details are set forth in order to provide a thorough understanding thereof. It may be evident, however, that the innovation can be practiced without these specific details. In other instances, well-known structures and devices are shown in block diagram form in order to facilitate a description thereof.

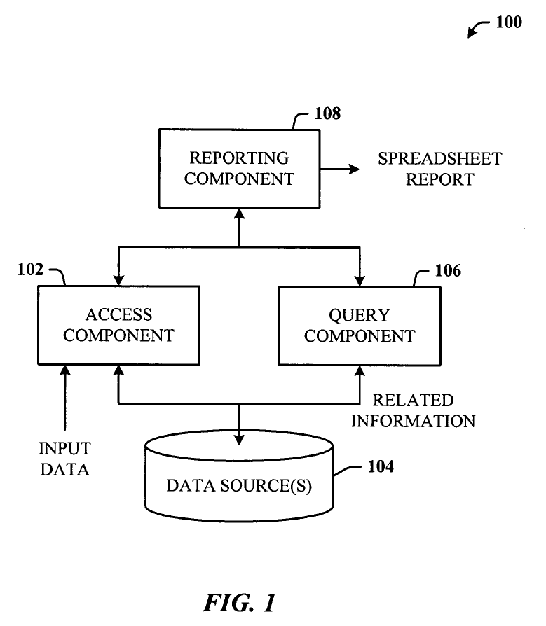

Referring initially to the drawings, FIG. 1 illustrates a system 100 that facilitates data management in accordance with the disclosed innovation. The system 100 includes an access component 102 for recursively accessing one or more data sources 104 for relevant information. In other words, the user or other processes input data into the access component 102 for recursive processing of a search (or query) against the data sources 104 for information relevant to the input data (e.g., an intended goal), for example. In one implementation, the data sources 104 include a hierarchical data structure (or database) of business definitions that are searched for the relevant performance (or metrics) information. In another implementation the data sources 104 include unstructured information (e.g., comments, notes) as well as structured information that are searched for the relevant information (e.g., performance metrics).

In response to receiving the relevant information via the access component 102, a query component 106 facilitates (e.g., manually, automatically, dynamically) generation of one or more queries for execution against the data sources 104 for information related to the relevant information using terms, phrases and/or content (e.g., text data, image data, audio data, video data, metadata) from the returned relevant information. When the related information is returned, both the relevant and related information are passed to a reporting component 108 for processing into a spreadsheet, and then output as desired (e.g., presentation, background processing).

The data sources 104 can include a wide variety of data sources at different locations. For example, the data sources 104 can include one or more backend data sources of a corporate enterprise from which relevant and/or related information is searched and returned. In other words, the relevant information returned via the access component 102 provides the basis to then seek out and search other data sources for related information, whether the sources are internal corporate entities (e.g., intranet structured or unstructured data) or external data sources (e.g., Internet structured or unstructured data).

In one embodiment, a user generates a scorecard of KPIs for viewing certain corporate information. The system 100 provides the capability for a user to select a KPI entry, initiate recursive access to hierarchical business definitions to visit all relevant data structures for results, query for related information based on those results, organize the relevant and related information, and output the total information to a spreadsheet for user interaction.

Other capabilities of the system 100 include the following: input to the spreadsheet can be in a compressed XML (extensible markup language) format, the relevant and related information can include unstructured data (e.g., comments), the report can be automatically and/or manually distributed via a messaging technology (e.g., e-mail), the spreadsheet report can be partitioned into smaller reports and presented over multiple presentation units (e.g., slides, user interface pages, documents), content included as part of the spreadsheet can be auto-sized, themes and formatting can be applied appropriately, and images can be compressed in an output format.

Caching of data is provided to facilitate data access, report generation, searching and spreadsheet formatting and presentation, for example. Caching also supports scaling out the system 100 and for loading balancing of the relevant and/or related information.

The system 100 also can provide automated capture of documents or data (e.g., snapshots), the grouping of spreadsheet slides by category (e.g., a key performance indicator (KPI)), break-out of spreadsheet sheets for presentation by dimension members, and automatic generation of end-user briefing books by subscription.

The subject innovations finds application to businesses for computing report metrics associated with business performance across many different areas. For example, a high-level executive may choose to see relevant information associated with corporate bottom line such as financial information. However, the executive cannot truly act on this information without underlying data that supports the reasons for how the financial information was developed. Upstream information compiled to arrive at the financial information can include customer satisfaction information (e.g., are customers happy, are deliveries on time, is the customer getting what was ordered, etc.) which influences the financial reports.

Upstream from customer information can be internal corporate process strategy—is the right strategy in place, is the company making the product the right way—all of which can affect customer satisfaction. Even further upstream can be employee development—are the right people being employed, are the right people being retained, is training adequate, etc. These four categories are extremely broad across the company, however, and when computed can generate a large amount of information as part of the overall financial well-being of the company. The innovation provides a means for limiting the amount of information returned to relevant information. Additionally, other associated structured and unstructured data can be searched and provided to the executive, as desired, thereby reducing the amount of information that would otherwise be perused.

To generate a measure of customer satisfaction, for example, drill down for information can include heterogeneous metrics associated with disparate customer information such as product defects, customer response, and repeat sales. Homogeneous drill down is into the same category of information, for example, where only product defects that can provide a single measuring value across all defects information (e.g., failures per million).

Drill-down can also include searching and retrieving unstructured data such as subordinate reports, annotations, white papers, and so on, for example, customer satisfaction related to product defects, further related to the state of Alabama and the specific product. Thus, related information such as technical reports can be retrieved about the product, product ratings, specifications, defect data, etc., associated with the product (or service). Accordingly, this can be by data structure hierarchy.

Based on the returned relevant and/or related information trend charts, graphs, breakdowns, and data driven reports can be generated and viewed. These reports can be formatted into the spreadsheet for presentation and/or other purposes. For example, conversion into spreadsheet compressed XML format can put the information into a format that can further be utilized by other processes suited to receive such a format. Charts, graphs, etc., based on the imported information can be generated via the spreadsheet program. Alternatively, the charts, graphs, etc., can be imported into the spreadsheet natively such that the information can be further processed and manipulated by the spreadsheet program.

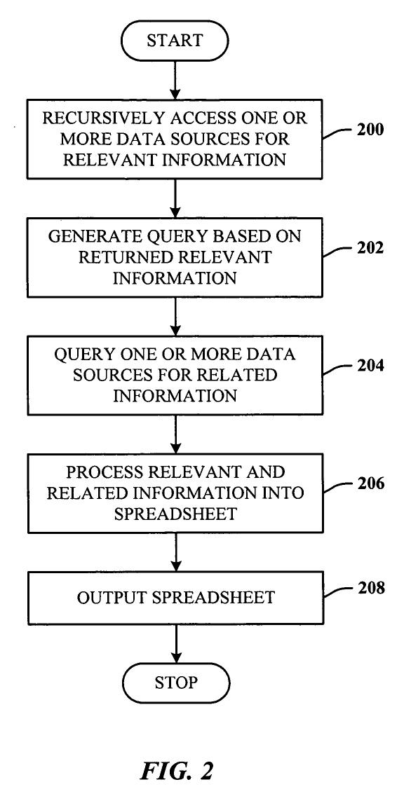

FIG. 2 illustrates a method of managing data in accordance with the innovation. While, for purposes of simplicity of explanation, the one or more methodologies shown herein, for example, in the form of a flow chart or flow diagram, are shown and described as a series of acts, it is to be understood and appreciated that the subject innovation is not limited by the order of acts, as some acts may, in accordance therewith, occur in a different order and/or concurrently with other acts from that shown and described herein. For example, those skilled in the art will understand and appreciate that a methodology could alternatively be represented as a series of interrelated states or events, such as in a state diagram. Moreover, not all illustrated acts may be required to implement a methodology in accordance with the innovation.

At 200, data of a data source is accessed recursively for relevant information. At 202, a query is generated based on the relevant information. At 204, the query is executed (e.g., recursively) against one or more data sources (e.g., the same or different) for related information. At 206, the relevant information and related information are processed into a spreadsheet. At 208, the spreadsheet is then output. Output processing can include presenting all or portions of the spreadsheet to a user via a spreadsheet program and/or performing background processing on the spreadsheet data for other purposes. For example, given that some or all of the data has now been formatted as spreadsheet data, the data can be selectively accessed for additional processing.

In one implementation, the system predicts the output file size and based on the predicted file size, presents a notification or warning to the user and/or system. This can be made a user-selectable option to set a file size threshold to a predetermined value such that when the file size value is exceeded, the warning is presented. Note that the output file size can be based on the relevant information, the related information or a combination of the relevant and related information.

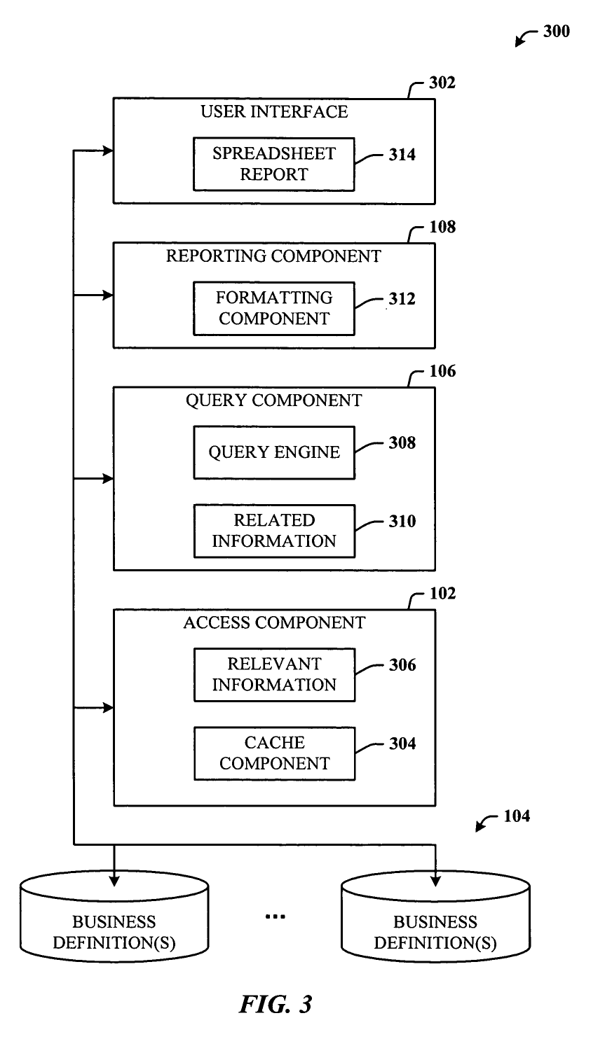

FIG. 3 illustrates an alternative system 300 for recursively accessing data and outputting information into a spreadsheet. The system 300 can include the access component 102 for accessing one or more data sources 104, the query component 106 developing and executing one or more queries, and the reporting component 108 for outputting a report in the form of a spreadsheet or a report that includes one or more of the spreadsheets. The system 300 can further include a user interface 302 that facilitates user interaction with the system 300 and one more of its components (102, 104, 106 and/or 108) for configuration, settings, and viewing reports, for example.

As described supra, the access component 102 accesses the one or more data sources 104 (which can be business definitions) under execution of a user setting, for example, input via the user interface 302. Alternatively, the system 300 can be configured to always access one or more of the same data sources 104. However, it is to be understood that the data sources 104 can be a local data store of the system 300, disposed as a one or more data stores of an enterprise network, and/or one or more data stores of an external network (e.g., the Internet). In the context of business definitions information, information which in most cases is desired to be protected, appropriate security protocols and measures can be employed to only allow access by authorized systems and/or users.

Here, the access component 102 employs a cache component 304 for caching data accessed from the data sources 104. In other words, it is to be appreciated that data accessed on the one or more data sources 104 can include same or similar data that is accessed for report generation. Accordingly, caching can provide a system and user enhancement by speeding up the processing associated with the system 300 for at least accessing and processing relevant information 306.

Pre-fetching and/or pre-caching information as a function of user preference, state, context or other metrics enhances a user experience and offsets some of the inherent limitations (e.g., bandwidth, memory, processing capability, display real estate . . . ) of portable devices as compared to desktop computers. It is to be appreciated that the information deemed of low value based on device capabilities and user-related metrics can be selectively aged out of storage to make room for new content.

Additionally, the cache component 304 can support data processing and handling by the query component 106 in the context of developing a query and executing the query using a query engine 308 (of the query component 106) to return related information 310. The query engine 308 can execute the query through the access component 102 and associated cache component 304. In other words, in one implementation, the query engine 308 can first check for information in the cache component 304, and then proceed to access the one or more data sources 104 through the access component 102. In an alternative implementation, the query engine 308 can execute the query directly against the one or more data sources 104. In yet another implementation, the query component 106 can include its own caching subsystem (not shown) that operates separately from the access component cache component 304.

Once the relevant information 306 and/or related information 310 is obtained, one or both can be passed to the reporting component 108 where a formatting component 312 formats the information (relevant 306 and/or related 310) for inclusion into the spreadsheet, and forwards the spreadsheet to the user interface 302 for presentation to the user as the spreadsheet report 314. As indicated previously, the spreadsheet information can be utilized in background processes for other purposes. It is not a requirement that the spreadsheet be presented to the user. In a more robust implementation, the spreadsheet is presented to the user and all or selected portions thereof are utilized in background processes (on this system 300) or other processes on other remote systems (not shown).

As described herein, the access component 102 facilitates accessing the one or more data sources 104 (or hierarchical structure of business definitions) recursively to find the desired relevant information 306. Should the query component 106 process the query through the access component 102, the query can also be processed recursively against the one or more data sources 104 to return the related information 310. Alternatively, the query component 106 can query the one or more data sources 104 (or hierarchical structure of business definitions) directly and recursively for the related information 310.

The system 300 also facilitates load balancing by caching information while also providing the capability to access information from persisted sources such as the data sources 104.

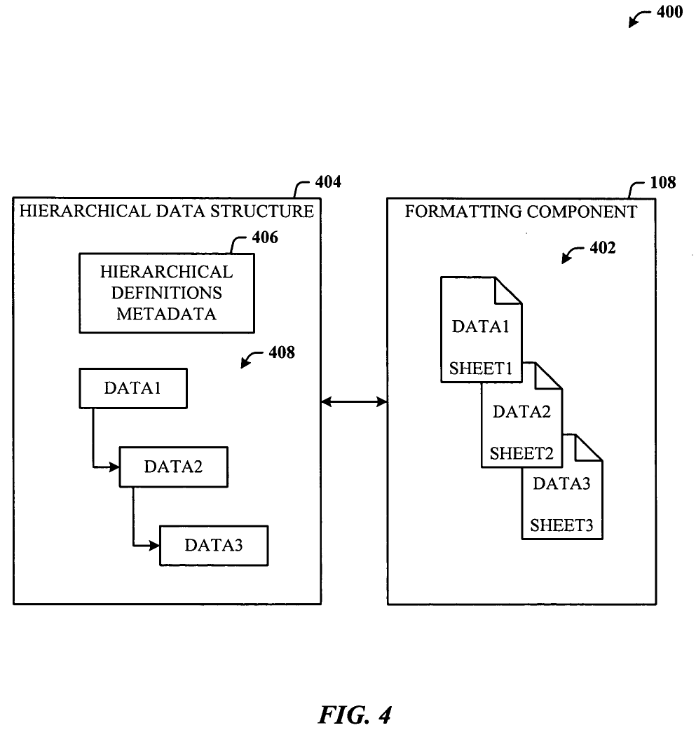

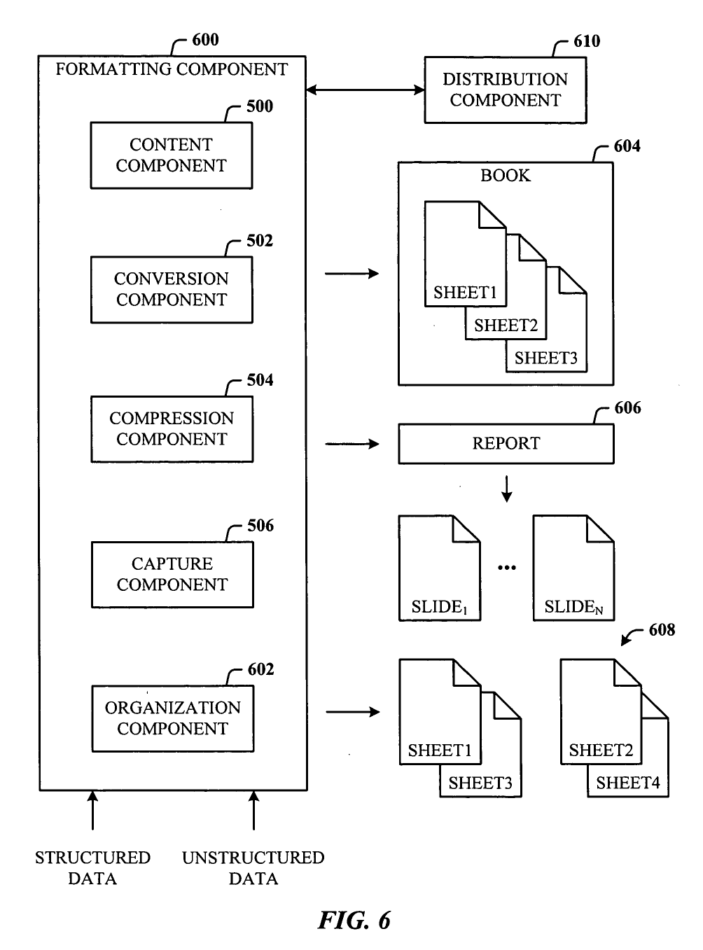

FIG. 4 illustrates a system 400 wherein the formatting component 108 employs hierarchical data to generate a structured spreadsheet report 402 (similar to spreadsheet report 314). In a hierarchical data structure 404, definitions metadata 406 can be employed to describe relationships of an associated hierarchical data structure 408. Here, the structure 408 includes first data (DATA1) at a top level, second data (DATA2) under the first data, and third data (DATA3) under the second data. The formatting component 108 can obtain this relationship information from the hierarchical definitions metadata 406, and use this data to organize sheets of the spreadsheet report 402. Here, relevant and/or related information obtained from the structure 408 is reported in a similar structure of the spreadsheet report 402. For example, represented simplistically, information associated with first data (DATA1) is presented in the report 402 on a first sheet (SHEET1), the second data (DATA2) is presented in the report 402 on a second sheet (SHEET2), and the third data (DATA3) is presented on a third sheet (SHEET3) of the report 402. Other organizational configurations can be employed, as will be described infra with respect to FIG. 6.

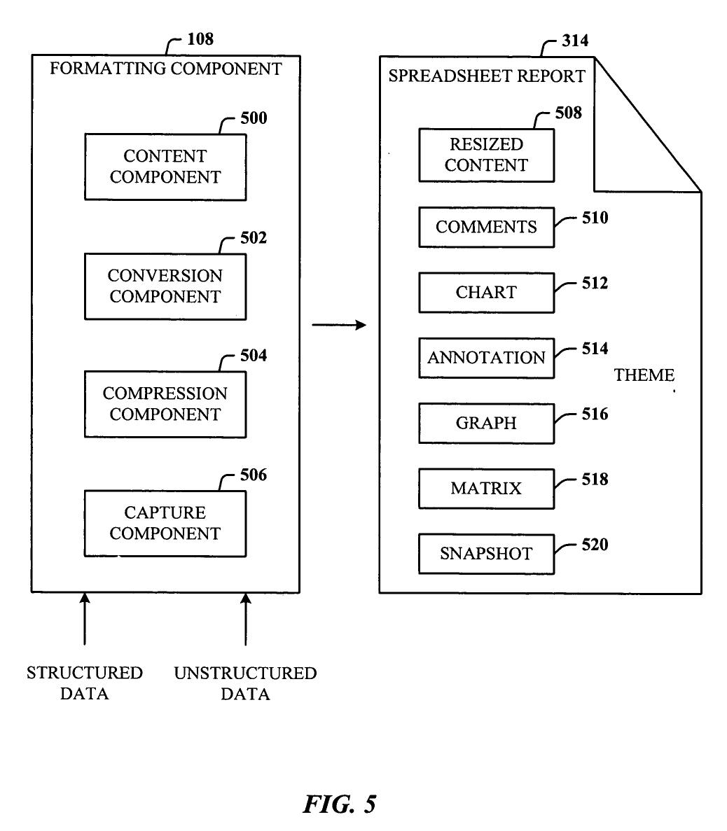

FIG. 5 illustrates components associated with the formatting component 108 that can be employed for preparing and inserting information into the spreadsheet report 314. The formatting component 108 can include a content component 500 for preparing content for insertion by, for example, automatically resizing the content based on available real estate of a sheet in which the content is intended to be presented. For example, if text content (included as part of the relevant and/or related information) is determined to take a significant portion of a sheet, given that there may be other content (a graph) that should also be presented on that sheet, the content component 500 can automatically configure the column and/or row settings of the spreadsheet program to provide a more suitable presentation that includes both the textual content and the associated graph content.

In support of such capabilities, the formatting component 108 can also include a conversion component 502 for converting relevant and/or related information into a format suitable for the spreadsheet program. For example, information returned is not limited to textual content, but can also include image content in the form of image file formats (e.g., TIFF, GIFF, PDF, JPEG). For example, according to one user configuration setting, image content returned for spreadsheet presentation can be limited to a small file format such as JPEG, in order to reduce the file size of the spreadsheet report 314. This capability is particularly useful when the user device is a handheld portable device (e.g., cell phone) having reducing processing and presentation capabilities. As service providers strive to provide more services, this capability to automatically accommodate spreadsheet reporting based on device capabilities (or lack thereof) can be a benefit.

Along these same lines, the formatting component 108 can include a compression component 504 for compressing content (e.g., image, text) for insertion, and/or the whole spreadsheet report 314 for transmission or other forms of processing. The capability to accommodate many different device software and/or hardware limitations is supported by not only converting content into the desired format and/or file size but also by compressing information for more expeditious handling. This can include secure compression of some or all of the content within the report 314 thereby controlling what the intended or untended recipient can perceive or systems can access. In one example, the capability to output a compressed XML (extensible markup language) format is provided.

The formatting component 108 can also include a capture component 506 for image capture (or snapshot) of information for processing into the report 314. The capture component 506 can include the capability of, for example, obtaining information captured and stored in a clipboard file. Other capture capabilities can include receiving image and/or video content received by a camera system, which is commonly included as part of handheld devices such a mobile phones and portable computers, and which can be provided in video conferencing systems and desktop computing camera systems.

Note that the capture component 506 can be associated with compiling a “snapshot” of the state of data at a particular point in time, rather than image capture. Accordingly, data snapshots can be presented in support of showing the progression or changes in information models over time. In the context of KPIs, data snapshots can be of particular importance to monitor changes in corporate well-being, for example. In all cases, the capture component 506 can be operated automatically and/or manually, based on user configurations.

Here, the formatting component 108 can receive structured and unstructured data (relevant and/or related information) for content, conversion, compression and/or capture processing into the spreadsheet report 314. The content in the report 314 can include, for example, resized content 508 (not only for visual resizing, but also for resolution), comments 510, charts 512, annotations 514, graphs 516, matrices 518 and snapshots 520. The report 314 can also be formatted to include theme information (e.g., background image, watermark, and coloring).

Note that the components (500, 502, 504 and 506) need not be internal to the formatting component 108, but can be separate therefrom, as desired by the particular design and application.

FIG. 6 illustrates an alternative implementation of a formatting component 600 that includes an organizational component 602 for organizing and outputting a spreadsheet report in predetermined ways. The alternative formatting component 600 can not only include the components (500, 502, 504 and 506) for content, conversion, compression and capture processing as described herein, but can also include the organization component 602 for organizing the relevant and/or related information for presentation and processing.

For example, the organization component 602 can facilitate the generation of the spreadsheet report as a briefing book 604 that presents the information and/or sheets (SHEET1, SHEET2 and SHEET3) in a predetermined order. For example, the information and/or sheets can be ordered according to KPI information or the intended recipient. Additionally, the book can include multiple generated spreadsheets each addressing different sets of relevant and related information.

It is also conceivable that the information received can be of such quantity or volume that presentation is more suitable in smaller pieces of output. Accordingly, a large report 606 can be organized into smaller report entities, such as slides (denoted SLIDE₁, . . . , SLIDE_{N}, where N is a positive integer). This can also be made a configurable user setting such that once set, the system will automatically monitor the report size, and once exceeded, the report 606 will be automatically parsed into more manageable chunks such as slides, for more efficient presentation.

The organization component 602 also facilitates organizing a report according to item properties (also called dimension members) such as customer, cost, product, and so on, when in a business definition context. This will be shown with respect to the user interface described hereinbelow. For example, a report comprised of four sheets 608 (denoted SHEET1, SHEET2, SHEET3 and SHEET4) can be presented as sheets associated with two dimension members that represent customer and customer country. Accordingly, when the relevant and/or related information is accessed, queried and returned, the information can be organized as customer information on SHEET1 and SHEET3, and customer country on SHEET2 and SHEET4. It is to be appreciated that the information can be organized before presentation such that sheet ordering is not necessary. In other words, in one implementation, the returned information is inserted into the spreadsheet, and then organized by sheet for the intended purposes. Alternatively, as before, the returned information is organized in system processes prior to being inserted into the spreadsheet.

A distribution component 610 is provided for communicating the report by many different communications technologies, for example, e-mail, instant messaging, wireless/wired communications, network, etc. If, for example, the user has indicated that the report will be sent via e-mail versus locally presented on the user machine, it can be beneficial to prepare the report for distribution by compression, formatting into a suitable communications protocol, and so on. If the user knows the report is intended for mobile users only, the distribution component 610 can feed this information back to the formatting component 600 such that the spreadsheet can be reprocessed down to a more suitable size for mobile device receipt and processing, if needed. Moreover, the distribution component 610 can support a subscription service such that the spreadsheet report will be compiled and distributed based on subscription by selected users, for example. The report can be pushed to the distribution system 610 asynchronously, or the distribution system 610 can pull the report by triggering automatic report generation based on scheduling information.

These are only but a few of the organizational capabilities provided by the organization component 602. For example, other information ordering can be according to time, date, user, based on user preferences, user rank in the company, recipient, report content, report size, and so on.

The following description will be in the context of business definitions; however, it is to be understood that the type and content of the relevant and/or related information desired can apply to many different contexts.

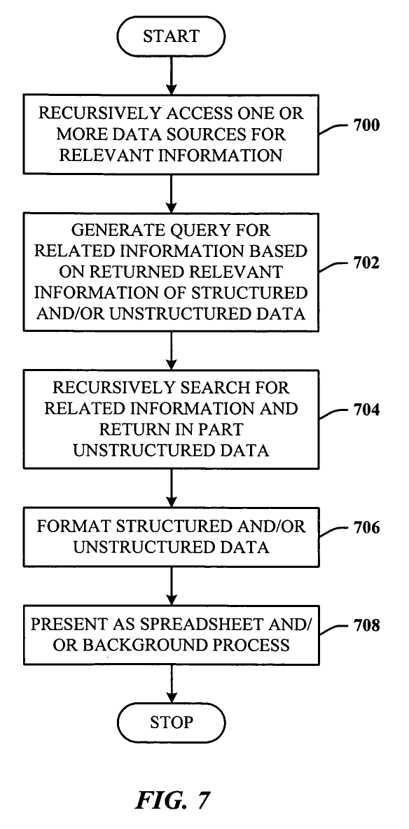

FIG. 7 illustrates a method of processing unstructured data for inclusion in a spreadsheet. At 700, one or more data sources are recursively accessed for the desired relevant information, which can be structured and/or unstructured data. The data can include business data related to sales, customers, orders, taxes, costs, employees, and so on, for generating a spreadsheet scorecard report (of selected KPIs) for company performance. At 702, based on the returned relevant information, a query is generated. At 704, the query is executed for related information (e.g., against back-end data sources). The related information, as well as the relevant information, can include unstructured data, such as comments, annotations, images, audio data, video data, data from the body of a document, e-mail, surveys, letters, chats, news groups, web pages, blogs, forums, etc. At 704, the query is executed recursively for the related information. Once returned, the unstructured data can be formatted (e.g., auto-sized, converted, compressed, grouped) as described herein, for insertion into a spreadsheet, as indicated at 706. At 708, once formatted, the information (relevant/related, structured/unstructured) can be presented as a spreadsheet document and/or utilized for background processing for other purposes.

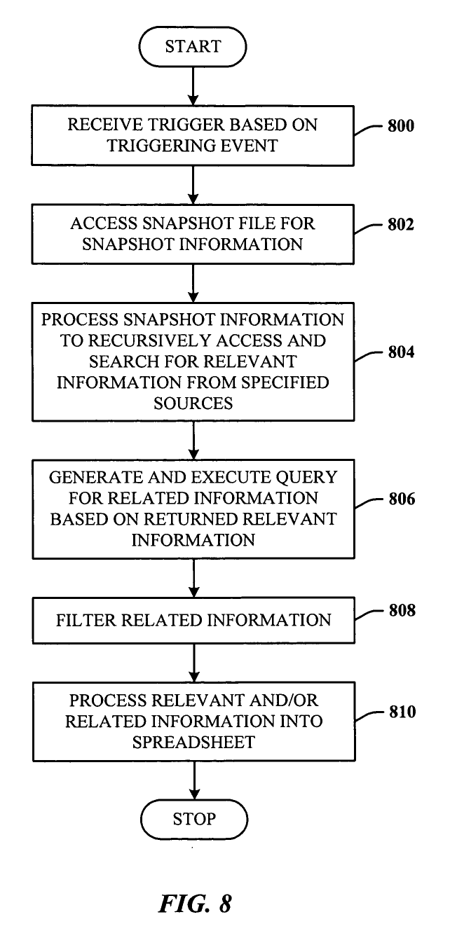

FIG. 8 illustrates a method of capturing information for presentation in a spreadsheet. At 800, a triggering event occurs. This can be a scheduled event such that when the time/date arrives, the system automatically executes to take a snapshot of the selected business data at that time. At 802, a snapshot file can be accessed that includes snapshot information associated with the relevant information to be searched, the data sources to be accessed, type of systems (e.g., applications, computing systems) or files to access, business units, performance information, etc. The snapshot data is then processed for inclusion into a spreadsheet. At 804, the snapshot results are returned, and form the basis for query formulation and execution against the same or other data sources, as indicated at 806. At 808, a filter can be applied to the returned information to filter out relevant and/or related information based on filter criteria. Once filtered, at 810, the results are formatted and/or converted for insertion into the spreadsheet.

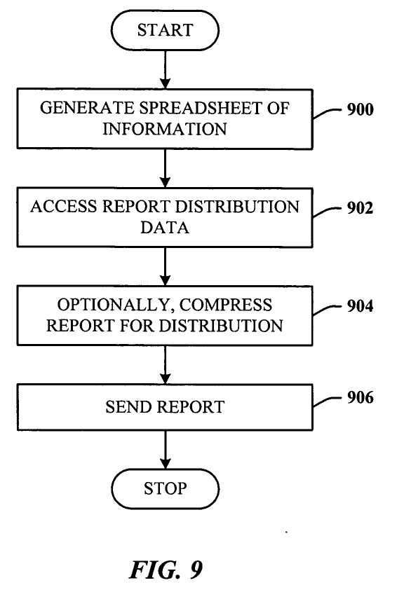

FIG. 9 illustrates a method of distributing a spreadsheet report in accordance with the innovation. At 900, a spreadsheet is generated that includes relevant/related information and/or structured/unstructured data. This can include a snapshot report for capturing the state of business information as a particular point in time or event (e.g., received new shipment of goods). At 902, distribution data can be accessed that defines how the report should be distributed and the recipients. For example, in a collaborative context, the report can be automatically distributed by e-mail to each or selected collaboration participants. In another example, the report can be distributed and posted on the collaboration site prior to the scheduled collaboration event. At 904, based on the method of distribution, the report can be compressed. For example, if it is known that the report was to be sent to a device with limited processing and presentation capabilities (e.g., a recipient is on travel with only a cell phone) compression can facilitate more efficient communications and processing. At 906, the report to is sent to the recipients (e.g., subscribers).

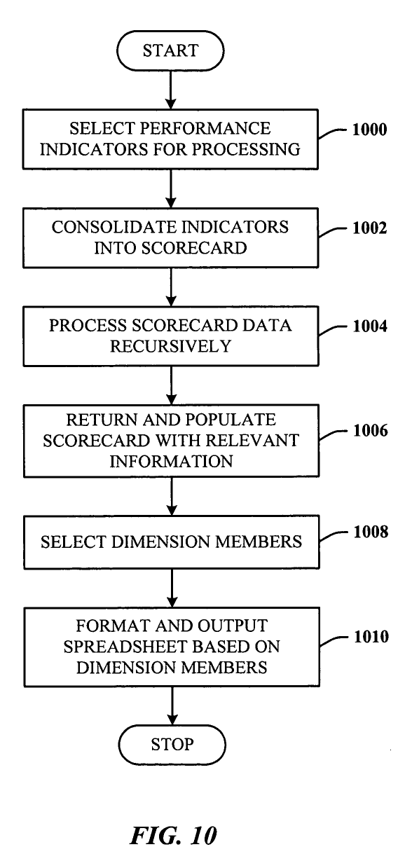

FIG. 10 illustrates a method of organizing and presenting business information by dimension members. At 1000, one or more performance indicators (e.g., KPIs) are selected for processing into a scorecard. At 1002, the indicators are consolidated into the scorecard. At 1004, the scorecard is processed recursively against one or more data sources for relevant information (e.g., dollar amounts, quantity data). At 1006, the relevant information is returned and populates the scorecard. It is to be understood that when the recursive processing is being performed for the relevant information, query development and processing can be in preparation for related information, as the relevant information is being returned.

Some, none or all of the related information can be presented via the spreadsheet. This related information can be cached for access should further processing required it. At 1008, the user can select one or more dimension members (e.g., customer categories such as address, phone, occupation, income, date) for spreadsheet reporting. At 1010, based on the dimension members, the spreadsheet is formatted for output. For example, in one implementation, a sheet can be presented for each member. In another implementation, members can be grouped such that single sheet presents the grouped members and associated relevant and/or related information. In yet another configuration, sheets of the spreadsheet can be organized according to KPI category and then according to dimension member of that category.

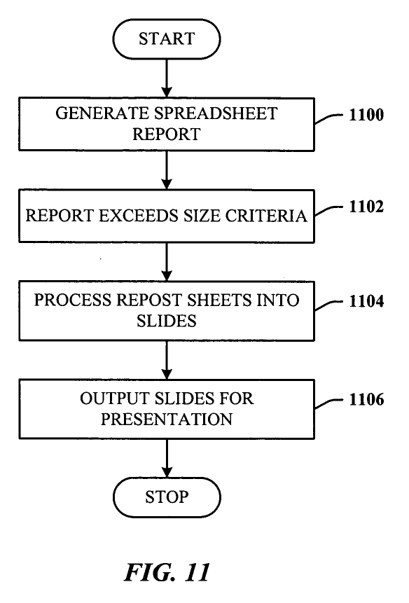

It can be appreciated that the system facilitates flexibility for a wide variety of sheet organization and groupings. For example, FIG. 11 illustrates a method of organizing spreadsheet output according to a slides format. At 1100, a spreadsheet report is generated. At 1102, a check is made that determines the report exceeds size criteria. The size criteria can indicate the file size; however, this may not be sufficiently definitive to decide to break the report into smaller entities. For example, if the spreadsheet content includes images, this can provide a false indication as to the actual file size. The size criteria can also include the number of sheets created as part of the overall spreadsheet. Accordingly, if the number of sheets exceeds a predetermined value, the innovation facilitates processing the sheets into slides, as indicated at 1104. At 1106, the slides are output for presentation.

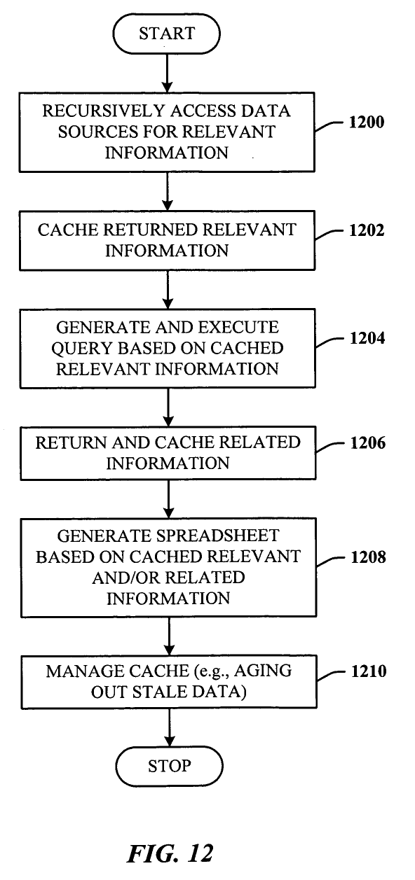

FIG. 12 illustrates a method of caching information in support of generating a spreadsheet of business performance information. At 1200, one or more data sources are accessed recursively for relevant information. At 1202, relevant information returned from data source access is cached for faster access. At 1204, a query is generated and recursively executed based on the cached relevant information. At 1206, related information is returned and cached. At 1208, a spreadsheet is generated using cached relevant and/or related information. At 1210, the cache is then managed to retain or age out stale data, as needed.

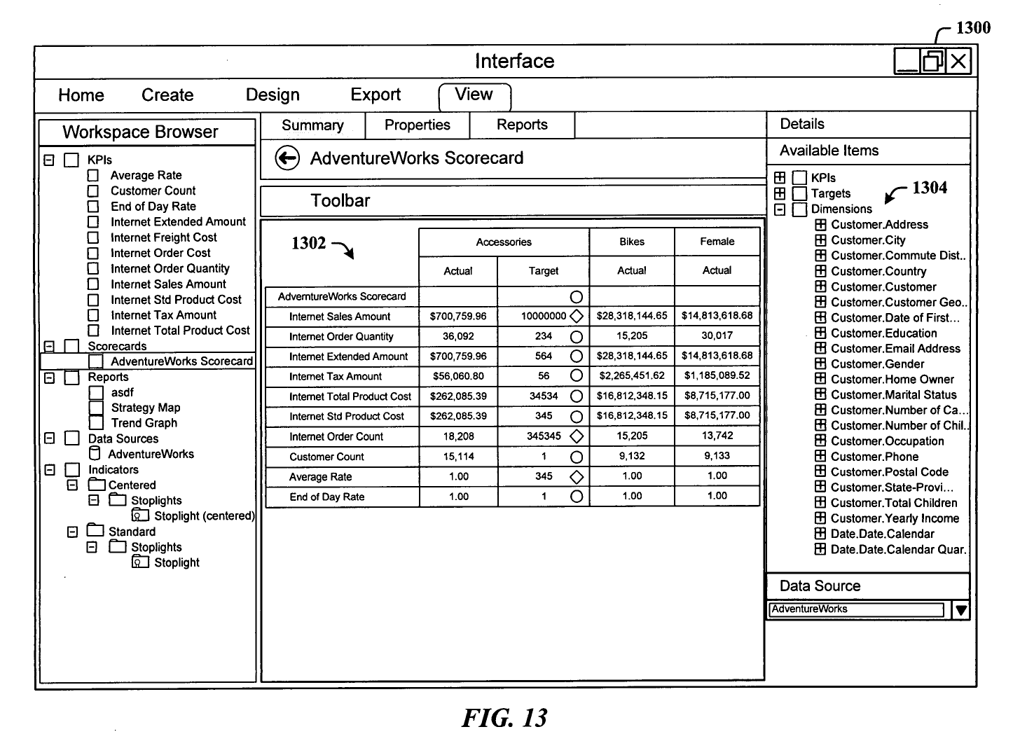

FIG. 13 illustrates a screenshot (or page) 1300 of a scorecard of KPI information obtained and compiled from a search for reporting via a spreadsheet. The user interface 302 of FIG. 3 facilitates user interaction for defining settings for generating a scorecard for viewing business performance information. A scorecard can include one or more performance indicators where the overall score of the scorecard can be used as a KPI for another scorecard. In other words, it is possible to generate a scorecard of scorecards. For example, a scorecard of scorecards can be provided in preparation for a meeting. The user interface can present a page that includes an objective scorecard, objective commentary as well as objective metadata, such as owner, effective start and end dates, documents and links, and description.

As can be seen in the scorecard of FIG. 13, the scorecard 1302 can include many different KPIs that according to the user can define performance parameters for an AdventureWorks entity. The Target column includes graphical indicia (e.g., circles, diamonds) associated with a target goals (e.g., dollar amounts, quantities). The user can select the graphical indicia, for example, the diamond associated with “Internet Sales Amount”, to move down into the context of the child objective. The objective scorecard 1302, commentary, and objective metadata on the page 1300 can all be updated in place to reflect the “Internet Sales Amount” objective. Overall, all elements of the scorecard 1302 can be updated by recursively accessing one or more data sources for the line item data. The page 1300 can also display dimension members 1304 from which can be selected one or more members according to which the spreadsheet can be parsed for presentation, for example.

KPIs defined on the left under Workspace Browser can be selected and dragged to the center work area and then automatically become part of scorecard 1302. On right is the list of dimension members. The items under the Browser can be thought of as the heterogeneous information, and the information listed under the Available Items, as homogeneous information of the KPIs. For example, the Customer.gender dimension can be dragged over on top of the Internet Sales Amount KPI entry. In response, the scorecard 1302 will automatically break out the sales between male and female, for all categories. Moreover, based on that breakdown, charts and graphs can be generated. Once dragged into center work area, the user can manually refresh the scorecard values. In another implementation, once the item is dragged into the scorecard 1302, the system can be configured to automatically or dynamically update the scorecard data.

On the left side of interface 1300, the user can select Reports, and the type of report output (e.g., Trend Graph). The system facilitates automatic generation of the chart in the spreadsheet. However, as indicated supra, functionality of spreadsheet program can also be employed to make the chart, graph, etc., if desired. The spreadsheet can also be exported to the web, as well.

The top row (denoted AdventureWorks Scorecard) of the scorecard 1302 is associated with a single dot (or indicia). The dot represents the heterogeneous rollup of all KPI metrics listed underneath in the scorecard 1302, which can also have a supporting report associated with it. The report can be a video, annotation, etc., but here, the dot is associated with one report, the trend graph. However, this is just one example, since there can be many reports associated and presented.

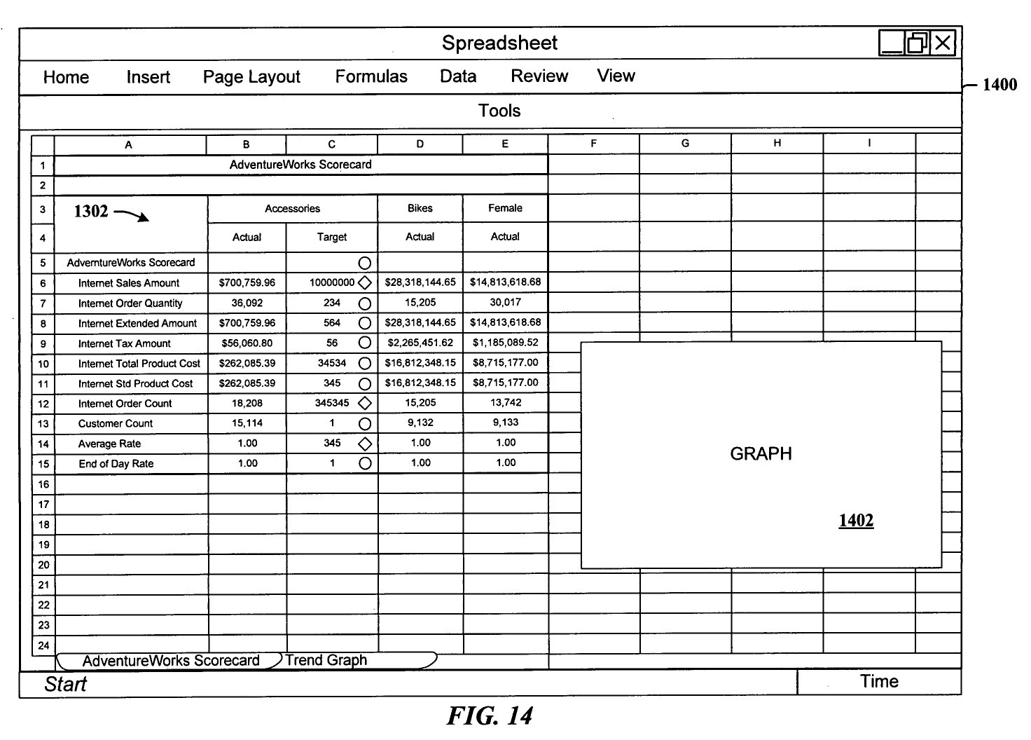

FIG. 14 illustrates a screenshot 1400 of a spreadsheet that now includes the KPI scorecard information 1302 compiled in FIG. 13. The scorecard information 1302 can be output on one sheet formatted for spreadsheet rows and columns. A graph 1402 (e.g., the trend graph) can be generated as part of generating the spreadsheet 1400 for output. Alternatively, the graph 1402 can be created by the user manually selecting a spreadsheet graphing option that graphs all or selected parameters of the scorecard information 1302.

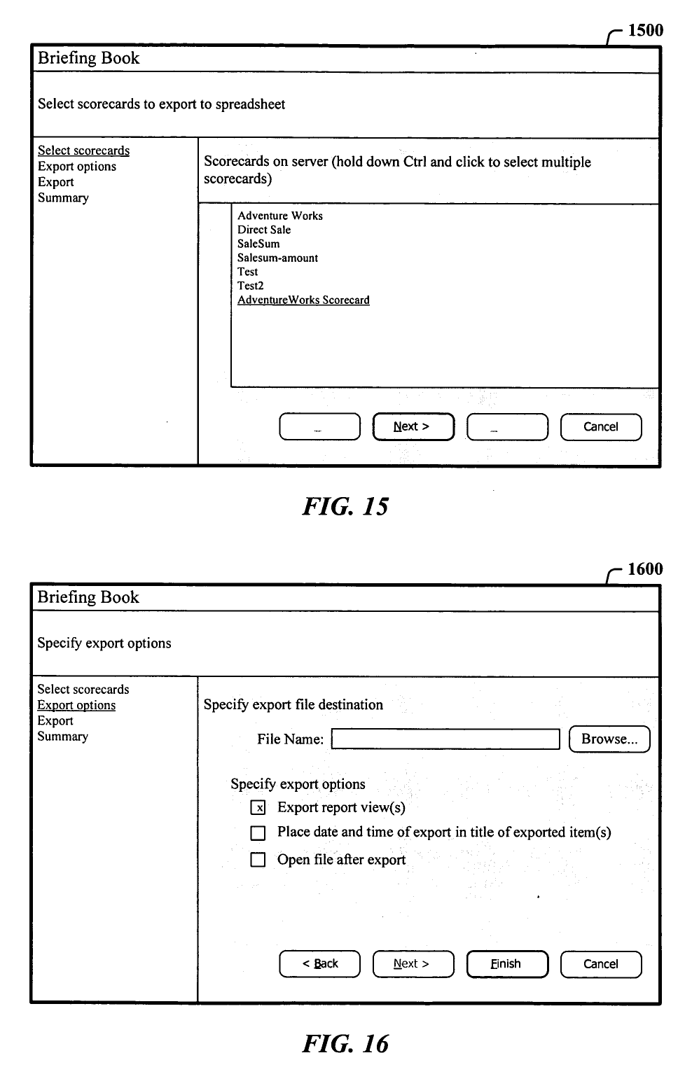

FIG. 15 illustrates a screenshot 1500 of one page of a user interface for selecting a scorecard to export to a spreadsheet and output as a briefing book. For example, prior to an executive review meeting, the user exports to PDF the marketing scorecard as well as all reports, charts and relevant documentation pertaining to a particular indicia (e.g., red colored) associated with a KPI listed in the scorecard 1302 of FIG. 13 (e.g., as a company rule, all such (red) indicators must have supporting documentation for the review) and select reports supporting another type of indicator (e.g., green) that have significantly outperformed targets, as well as those indicators trending negatively. The final report can then be printed out in twenty copies, for example, of the PDF-formatted documents. The user can export to JPEG the scorecards and reports referenced in agenda items and add the reports to a presentation program. The same set of reports can be exported to the spreadsheet program and e-mailed to the finance team. The reports can then be incorporated into other reports for analysis.

FIG. 16 illustrates a screenshot 1600 of one page of a user interface for specifying an export option for exporting a scorecard to a spreadsheet and output as a briefing book. After selecting an export option, the user is presented with the capability to define the filename and location of the output file. Other options allow for specifying the output as repot view, adding date and time in the title of the exported item and opening the file after the export operation has been completed.

While certain ways of displaying information to users are shown and described with respect to certain figures as screenshots, those skilled in the relevant art will recognize that various other alternatives can be employed. The terms “screen,” “screenshot”, “webpage,” “document”, and “page” are generally used interchangeably herein. The pages or screens are stored and/or transmitted as display descriptions, as graphical user interfaces, or by other methods of depicting information on a screen (whether personal computer, PDA, mobile telephone, or other suitable device, for example) where the layout and information or content to be displayed on the page is stored in memory, database, or another storage facility.

As used in this application, the terms “component” and “system” are intended to refer to a computer-related entity, either hardware, a combination of hardware and software, software, or software in execution. For example, a component can be, but is not limited to being, a process running on a processor, a processor, a hard disk drive, multiple storage drives (of optical and/or magnetic storage medium), an object, an executable, a thread of execution, a program, and/or a computer. By way of illustration, both an application running on a server and the server can be a component. One or more components can reside within a process and/or thread of execution, and a component can be localized on one computer and/or distributed between two or more computers.

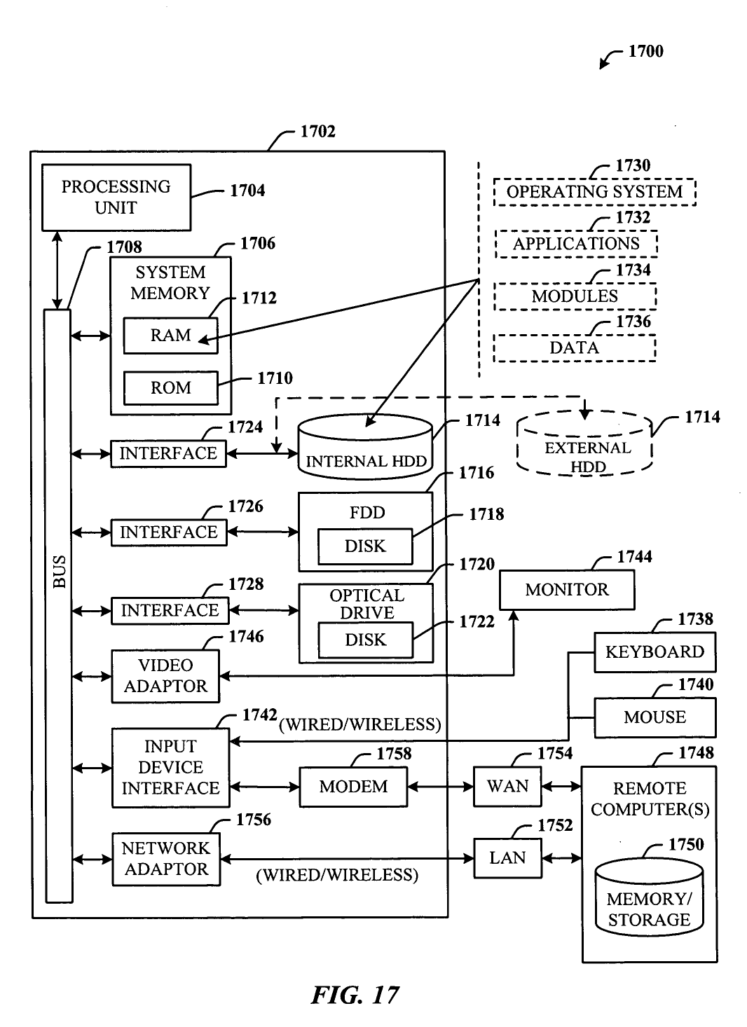

Referring now to FIG. 17, there is illustrated a block diagram of a computing system 1700 operable to execute the disclosed architecture for recursive access of relevant and/or related information for output into a spreadsheet. In order to provide additional context for various aspects thereof, FIG. 17 and the following discussion are intended to provide a brief, general description of a suitable computing system 1700 in which the various aspects of the innovation can be implemented. While the description above is in the general context of computer-executable instructions that may run on one or more computers, those skilled in the art will recognize that the innovation also can be implemented in combination with other program modules and/or as a combination of hardware and software.

Generally, program modules include routines, programs, components, data structures, etc., that perform particular tasks or implement particular abstract data types. Moreover, those skilled in the art will appreciate that the inventive methods can be practiced with other computer system configurations, including single-processor or multiprocessor computer systems, minicomputers, mainframe computers, as well as personal computers, hand-held computing devices, microprocessor-based or programmable consumer electronics, and the like, each of which can be operatively coupled to one or more associated devices.

The illustrated aspects of the innovation may also be practiced in distributed computing environments where certain tasks are performed by remote processing devices that are linked through a communications network. In a distributed computing environment, program modules can be located in both local and remote memory storage devices.

A computer typically includes a variety of computer-readable media. Computer-readable media can be any available media that can be accessed by the computer and includes volatile and non-volatile media, removable and non-removable media. By way of example, and not limitation, computer-readable media can comprise computer storage media and communication media. Computer storage media includes both volatile and non-volatile, removable and non-removable media implemented in any method or technology for storage of information such as computer-readable instructions, data structures, program modules or other data. Computer storage media includes, but is not limited to, RAM, ROM, EEPROM, flash memory or other memory technology, CD-ROM, digital video disk (DVD) or other optical disk storage, magnetic cassettes, magnetic tape, magnetic disk storage or other magnetic storage devices, or any other medium which can be used to store the desired information and which can be accessed by the computer.

With reference again to FIG. 17, the exemplary computing system 1700 for implementing various aspects includes a computer 1702, the computer 1702 including a processing unit 1704, a system memory 1706 and a system bus 1708. The system bus 1708 provides an interface for system components including, but not limited to, the system memory 1706 to the processing unit 1704. The processing unit 1704 can be any of various commercially available processors. Dual microprocessors and other multi-processor architectures may also be employed as the processing unit 1704.

The system bus 1708 can be any of several types of bus structure that may further interconnect to a memory bus (with or without a memory controller), a peripheral bus, and a local bus using any of a variety of commercially available bus architectures. The system memory 1706 includes read-only memory (ROM) 1710 and random access memory (RAM) 1712. A basic input/output system (BIOS) is stored in a non-volatile memory 1710 such as ROM, EPROM, EEPROM, which BIOS contains the basic routines that help to transfer information between elements within the computer 1702, such as during start-up. The RAM 1712 can also include a high-speed RAM such as static RAM for caching data.

The computer 1702 further includes an internal hard disk drive (HDD) 1714 (e.g., EIDE, SATA), which internal hard disk drive 1714 may also be configured for external use in a suitable chassis (not shown), a magnetic floppy disk drive (FDD) 1716, (e.g., to read from or write to a removable diskette 1718) and an optical disk drive 1720, (e.g., reading a CD-ROM disk 1722 or, to read from or write to other high capacity optical media such as the DVD). The hard disk drive 1714, magnetic disk drive 1716 and optical disk drive 1720 can be connected to the system bus 1708 by a hard disk drive interface 1724, a magnetic disk drive interface 1726 and an optical drive interface 1728, respectively. The interface 1724 for external drive implementations includes at least one or both of Universal Serial Bus (USB) and IEEE 1394 interface technologies. Other external drive connection technologies are within contemplation of the subject innovation.

The drives and their associated computer-readable media provide nonvolatile storage of data, data structures, computer-executable instructions, and so forth. For the computer 1702, the drives and media accommodate the storage of any data in a suitable digital format. Although the description of computer-readable media above refers to a HDD, a removable magnetic diskette, and a removable optical media such as a CD or DVD, it should be appreciated by those skilled in the art that other types of media which are readable by a computer, such as zip drives, magnetic cassettes, flash memory cards, cartridges, and the like, may also be used in the exemplary operating environment, and further, that any such media may contain computer-executable instructions for performing the methods of the disclosed innovation.

A number of program modules can be stored in the drives and RAM 1712, including an operating system 1730, one or more application programs 1732, other program modules 1734 and program data 1736. All or portions of the operating system, applications, modules, and/or data can also be cached in the RAM 1712. It is to be appreciated that the innovation can be implemented with various commercially available operating systems or combinations of operating systems. The programs 1732 and modules 1734 can include the components described herein for recursive access and processing for relevant and/or related information. Additionally, programs 1732 and modules 1734 can also provide the functionality associated with the user interface and formatting for reporting as a spreadsheet.

A user can enter commands and information into the computer 1702 through one or more wired/wireless input devices, for example, a keyboard 1738 and a pointing device, such as a mouse 1740. Other input devices (not shown) may include a microphone, an IR remote control, a joystick, a game pad, a stylus pen, touch screen, or the like. These and other input devices are often connected to the processing unit 1704 through an input device interface 1742 that is coupled to the system bus 1708, but can be connected by other interfaces, such as a parallel port, an IEEE 1394 serial port, a game port, a USB port, an IR interface, etc.

A monitor 1744 or other type of display device is also connected to the system bus 1708 via an interface, such as a video adapter 1746. In addition to the monitor 1744, a computer typically includes other peripheral output devices (not shown), such as speakers, printers, etc.

The computer 1702 may operate in a networked environment using logical connections via wired and/or wireless communications to one or more remote computers, such as a remote computer(s) 1748. The remote computer(s) 1748 can be a workstation, a server computer, a router, a personal computer, portable computer, microprocessor-based entertainment appliance, a peer device or other common network node, and typically includes many or all of the elements described relative to the computer 1702, although, for purposes of brevity, only a memory/storage device 1750 is illustrated. The logical connections depicted include wired/wireless connectivity to a local area network (LAN) 1752 and/or larger networks, for example, a wide area network (WAN) 1754. Such LAN and WAN networking environments are commonplace in offices and companies, and facilitate enterprise-wide computer networks, such as intranets, all of which may connect to a global communications network, for example, the Internet.

When used in a LAN networking environment, the computer 1702 is connected to the local network 1752 through a wired and/or wireless communication network interface or adapter 1756. The adaptor 1756 may facilitate wired or wireless communication to the LAN 1752, which may also include a wireless access point disposed thereon for communicating with the wireless adaptor 1756.

When used in a WAN networking environment, the computer 1702 can include a modem 1758, or is connected to a communications server on the WAN 1754, or has other means for establishing communications over the WAN 1754, such as by way of the Internet. The modem 1758, which can be internal or external and a wired or wireless device, is connected to the system bus 1708 via the serial port interface 1742. In a networked environment, program modules depicted relative to the computer 1702, or portions thereof, can be stored in the remote memory/storage device 1750. It will be appreciated that the network connections shown are exemplary and other means of establishing a communications link between the computers can be used.

The computer 1702 is operable to communicate with any wireless devices or entities operatively disposed in wireless communication, for example, a printer, scanner, desktop and/or portable computer, portable data assistant, communications satellite, any piece of equipment or location associated with a wirelessly detectable tag (e.g., a kiosk, news stand, restroom), and telephone. This includes at least Wi-Fi and Bluetooth™ wireless technologies. Thus, the communication can be a predefined structure as with a conventional network or simply an ad hoc communication between at least two devices.

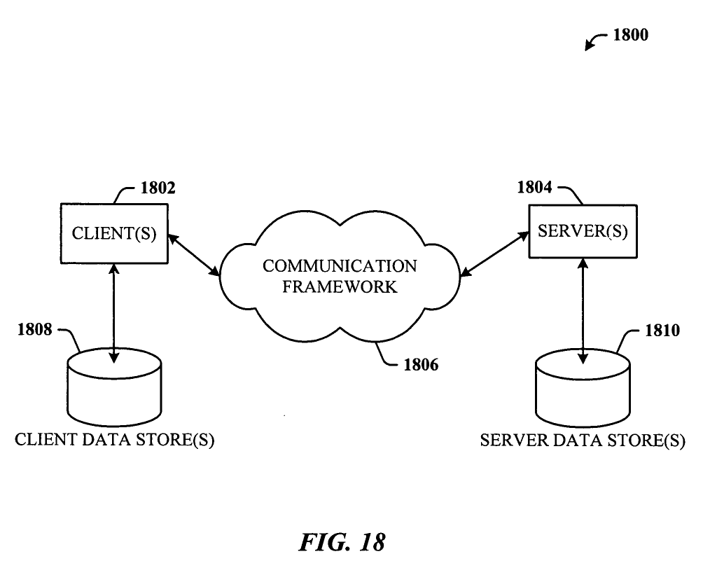

Referring now to FIG. 18, there is illustrated a schematic block diagram of an exemplary computing environment 1800 that recursive processing of business definitions for output in one or more spreadsheets. The system 1800 includes one or more client(s) 1802. The client(s) 1802 can be hardware and/or software (e.g., threads, processes, computing devices). The client(s) 1802 can house cookie(s) and/or associated contextual information by employing the subject innovation, for example.

The system 1800 also includes one or more server(s) 1804. The server(s) 1804 can also be hardware and/or software (e.g., threads, processes, computing devices). The servers 1804 can house threads to perform transformations by employing the architecture, for example. One possible communication between a client 1802 and a server 1804 can be in the form of a data packet adapted to be transmitted between two or more computer processes. The data packet may include a cookie and/or associated contextual information, for example. The system 1800 includes a communication framework 1806 (e.g., a global communication network such as the Internet) that can be employed to facilitate communications between the client(s) 1802 and the server(s) 1804.

Communications can be facilitated via a wired (including optical fiber) and/or wireless technology. The client(s) 1802 are operatively connected to one or more client data store(s) 1808 that can be employed to store information local to the client(s) 1802 (e.g., cookie(s) and/or associated contextual information). Similarly, the server(s) 1804 are operatively connected to one or more server data store(s) 1810 that can be employed to store information local to the servers 1804.

The client stores 1808 and the server stores 1810 can include the information of interest to be accessed and queried for formatting and output to the spreadsheet. Additionally, the clients 1802 can include many different types of devices, such as portable, mobile and networked devices. The servers 1804 can include a collaboration site where spreadsheet reports are distributed to collaboration participants. Additionally, the spreadsheets can be distributed to the clients 1802 via e-mail.

What has been described above includes examples of the disclosed innovation. It is, of course, not possible to describe every conceivable combination of components and/or methodologies, but one of ordinary skill in the art may recognize that many further combinations and permutations are possible. Accordingly, the innovation is intended to embrace all such alterations, modifications and variations that fall within the spirit and scope of the appended claims. Furthermore, to the extent that the term “includes” is used in either the detailed description or the claims, such term is intended to be inclusive in a manner similar to the term “comprising” as “comprising” is interpreted when employed as a transitional word in a claim.

What is claimed is:

1. A computer-implemented system that facilitates data management, comprising:
an access component for recursively accessing a data source for relevant information;
a query component for processing a query for related information; and
a reporting component for generating a spreadsheet that includes the relevant information and related information.

2. The system of claim 1, wherein the data source includes hierarchical business definition information.

3. The system of claim 1, wherein the spreadsheet generated by the reporting component includes structured and unstructured data.

4. The system of claim 1, further comprising a cache component for caching the relevant and/or related information.

5. The system of claim 1, further comprising a formatting component for automatically sizing content of the relevant and/or related information for presentation in the spreadsheet.

6. The system of claim 1, further comprising a formatting component for automatically compressing files associated with the spreadsheet in an XML format.

7. The system of claim 1, wherein the reporting component facilitates automatic distribution of the spreadsheet via a communications technology.

8. A computer-implemented method of managing data, comprising:
recursively accessing a data source for relevant performance information;
generating a query based on the relevant performance information;
recursively executing the query for related metrics information; and
processing the relevant performance information and related metrics information into a spreadsheet.

9. The method of claim 8, further comprising automatically creating a snapshot of information for inclusion into the spreadsheet.

10. The method of claim 8, further comprising automatically formatting the spreadsheet into slides when the spreadsheet meets predetermined size criteria.

11. The method of claim 10, further comprising automatically grouping the slides according to a performance metric.

12. The method of claim 8, further comprising one or more of:
presenting the relevant performance information and the related metrics information in the spreadsheet according to dimension members; and
predicting a file size of an output and presenting a warning when the file size exceeds a predetermined file size threshold.

13. The method of claim 8, further comprising recursively accessing homogeneous data associated with the relevant performance information.

14. The method of claim 8, further comprising recursively accessing heterogeneous data associated with the relevant performance information.

15. The method of claim 8, further comprising grouping the relevant performance information according to sheets of the spreadsheet.

16. The method of claim 8, further comprising generating a briefing book based in part on the spreadsheet and distributing the briefing book according to subscriber.

17. The method of claim 8, further comprising providing load balancing of the relevant performance information and related metrics information.

18. A computer-implemented system, comprising:
computer-implemented means for accessing a data source and generating a scorecard of business metrics;
computer-implemented means for recursively accessing heterogeneous business data of the data source based on the business metrics; and
computer-implemented means for processing the heterogeneous business data into a spreadsheet.

19. The system of claim 18, further comprising computer-implemented means for generating a query based on the heterogeneous business data and recursively accessing homogeneous business data based on the query.

20. The system of claim 18, further comprising computer-implemented means for automatically compressing the heterogeneous business data into the spreadsheet via an XML format.
